(19) United States
(12) Patent Application Publication
(10) Pub. No.: US 2015/0104678 A1
(43) Pub. Date: Apr. 16, 2015

(54) STRUCTURE FOR POWER ELECTRONIC PARTS HOUSING OF VEHICLE

(71) Applicant: Hyundai Motor Company, Seoul (KR)

(72) Inventors: Jin Woo KWAK, Gyeongsangbuk-do (KR); Kyong Hwa SONG, Seoul (KR); In Chang CHU, Seoul (KR)

(73) Assignee: Hyundai Motor Company, Seoul (KR)

(21) Appl. No.: 14/106,197

(22) Filed: Dec. 13, 2013

(30) Foreign Application Priority Data
Oct. 14, 2013 (KR) 10-2013-0121829

(51) Int. Cl. H01M 10/625

(52) U.S. Cl. CPC H01M 10/5016
USPC 429/10

(57) ABSTRACT

A structure for a housing of a power electronic part of a vehicle, particularly the battery, having varying thermal conductivity, the housing having insulation properties for solving heat dissipation and heat insulation problems. and controlling thermal conductivity depending on a surrounding environment is disclosed. The housing is manufactured with a hollow portion, configured to be filled with ellipsoidal magnetic particles coated with electrical insulation-type thermal conductive particles on their surfaces, and a containing a liquid fill in a state of being mixed with each other. Thermal conductivity is controlled by changing orientation of magnetic particles according to direction of a magnetic field applied by a magnetic field generating member.

### CROSS-REFERENCE TO RELATED APPLICATION

This application claims priority under 35 U.S.C. §119 to Korean Patent Application No. 10-2013-0121829, filed on Oct. 14, 2013, in the Korean Intellectual Property Office, the disclosure of which is incorporated herein by reference in its entirety.

### BACKGROUND

(a) Technical Field

The present disclosure relates to a structure for a housing of a power electronic part of a vehicle, and more particularly, to a structure for a housing of a power electronic part which has insulating properties and is able to control thermal conductivity depending on a surrounding environment.

(b) Background Art

Recently, there has been an increase in the number of power electronic parts mounted in a vehicle and subsequently large-scale integration thereof. Additionally, heat generation in a vehicle battery, which is one of main power electronic parts, has been emerging as a serious issue.

Particularly, in an environment-friendly vehicle such as an electric vehicle or a hybrid vehicle, reliability and stability of a battery system act as important factors to determine vehicle marketability. Therefore, it is important to maintain the battery system in an appropriate temperature range in order to prevent battery performance degradation due to change in outside temperature.

In general, it is known that the energy and output of a lithium-ion battery rapidly degrade when temperature decreases to −10° C. or less. For example, regarding the 18650 battery, it was reported that only 5% of the energy density and 1.25% of the output density can be transmitted in an environment of −40° C. as compared to the environment at 20° C. (G. Nagasubramanian, J Appl Electrochem, 31, 99. (2001)).

In addition, it was reported that a lithium-ion battery can be normally discharged but cannot be charged properly in a low-temperature environment (C. K. Huang, J. S. Sakamoto, J. Wolfenstine and S. Surampudi, J. Electrochem. Soc. 147 (2000) 2893; S. S. Zhang, K. Xu and T. R. Jow, Electrochim. Acta 48 (2002) 241).

It is known that the causes of performance degradation in a low-temperature environment are degraded ion conductivity of an electrolyte, a solid electrolyte membrane formed on the surface of graphite, low diffusibility of lithium ions to graphite, increase in charge transfer resistance at the interface between an electrolyte and an electrode, and the like (S. S. Zhang, K. Xu and T. R. Jow, J Power Sources 115, 137 (2003)). In order to solve this, additional heat insulation is needed for maintaining the temperature of the battery in an appropriate temperature range (for example, 35° C. to 50° C.).

In addition, while degradation of the output and performance of the battery in the low-temperature environment emerges as a problem as described above, in an environment in which an actual operation temperature is a high temperature, thermal runaway of the battery becomes a problem.

Therefore, there is a need for the development of a method to maintain the battery temperature in an appropriate temperature range to cope with changes in outside temperature.

In a case of excellent heat insulation, a heat dissipation problem occurs, and in a case of excellent heat dissipation, a heat insulation problem occurs due to high thermal conductivity. Therefore, there is a need to develop a method to maintain the temperature of a battery system at an appropriate temperature even in a low-temperature environment while being capable of maintaining excellent heat dissipation performance in general weather conditions.

Particularly, in an environment-friendly vehicle such as an electric vehicle or a hybrid vehicle, wherein the battery is the main power source of the vehicle, degradation of the output and performance of the battery directly results in degradation of the performance of the vehicle.

In related art, the development of heat control materials has been focused on improving the thermal conductivity of a material only from a viewpoint of heat dissipation. When a housing of a power electronic part such as a battery is needed for heat insulation, the housing has been manufactured by using additional foam or plastic material having low thermal conductivity.

This may not actively cope with each environment in which a single part needs both heat insulation and heat dissipation. In order to solve the heat dissipation and heat insulation problems at the same time, the housing is made of an insulating material and then the capacity of a blower as an air-cooling unit is increased or a water-cooling method is applied to reinforce heat dissipation performance and solve the heat dissipation problem, which results in a problem of an increase in the overall weight.

In addition, to solve the heat generation problem in a power electronic part for a vehicle, in particular a battery, extensive research has been conducted to configure a housing a composite material containing a filler having excellent thermal conductivity. However, even the heat dissipation composite material has a limit to the improvement in thermal conductivity, and in a case of a part manufactured by injection, thermal conductivity anisotropy occurs due to orientation of the filler in an injection direction.

More specifically, most polymer composite material resins that contain high-thermal-conductivity fillers developed to improve heat dissipation performance contain plate-like or fiber-type fillers. Therefore, when the resin is produced into a battery housing or the like by injection, the filler is uniaxially oriented in the injection direction due to the shear force in the injection direction, which results in the problem of thermal conductivity anisotropy. Accordingly, the thermal conductivity in the injection direction is about ⅓ to ¼ of the thermal conductivity in a thickness direction and is thus very low.

For efficient heat dissipation, heat transfer paths suitable for the shape and properties of a part have to be formed to obtain excellent heat dissipation effect by convection, and most housings for power electronic parts and batteries are manufactured to have heat transfer path properties in the thickness direction so as to enhance heat dissipation efficiency.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a structure having a varying thermal conductivity for a housing of a power electronic part, having insulation properties to solve heat dissipation and heat insulation problems in a power electronic part for a vehicle, particularly in a battery, and of controlling thermal conductivity depending on a surrounding environment by applying a simple control technique.

More particularly, the present invention in accord with one embodiment provides a smart housing material capable of controlling the formation of a heat transfer path in an environment-friendly vehicle such as an electric vehicle or a hybrid vehicle, thereby fundamentally solving a problem of degradation of the performance of a power electronic part (battery or the like) due to surrounding temperature, heat generation, and the like.

In one aspect, the present invention provides a structure which is manufactured in a shape having a hollow portion, configured to be filled with ellipsoidal magnetic particles coated with electrical insulation-type thermal conductive particles on their surfaces and a filling liquid fill in a state of being mixed with each other. Thermalconductivity is able to be controlled by changing orientation of the magnetic particles according to the direction of a magnetic field applied by a magnetic field generating member.

In a preferred embodiment, the magnetic particles may be one selected from (Fe) particles, cobalt (Co) particles, and nickel (Ni) particles, and as amorphous alloy metal particles, iron-cobalt alloy metal particles and nickel-ion alloy metal particles.

In another preferred embodiment, the thermal conductive particles may be one selected from boron nitride particles, alumina particles, magnesium oxide particles, silicon nitride particles, silicon carbide particles, and diamond particles.

In still another preferred embodiment, the filling liquid may be a silicone oil.

In yet another preferred embodiment, the structure may be molded to have the hollow portion using a thermal conductive engineering plastic that contains a thermal conductive filler, and may be configured to fill the hollow portion with a filler made of the magnetic particles and the filling liquid.

In still yet another preferred embodiment, the thermal conductive filler may be graphite or boron nitride formed as plate-like particles.

In a further preferred embodiment, the structure may be manufactured in a shape in which the hollow portion and the filler made of the magnetic particles and the filling liquid in the hollow portion are disposed to enclose a power electronic part and may be provided as a housing for the power electronic part.

In another further preferred embodiment, the structure may be provided as a battery housing, which is disposed to enclose a vehicle battery as the power electronic part.

In this manner, according to the present disclosure, it is possible to provide the structure which is configured to fill the hollow portion with the ellipsoidal magnetic particles coated with the electrical insulation-type thermal conductive particles in a state of being mixed with the filling liquid and thus can control thermal conductivity by changing the orientation of the magnetic particles according to the direction of the magnetic field.

The structure of the present disclosure is useful in configuring the housing for the power electronic part which selectively needs heat dissipation performance and heat insulation performance, such as the battery in an environment-friendly vehicle such as an electric vehicle or a hybrid vehicle.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view illustrating a structure of an embodiment, which is implemented as a housing of a power electronic part for a vehicle;

FIG. 2 is a schematic diagram illustrating an orientation state of magnetic particles filling a hollow portion of the structure in the present disclosure;

FIG. 3 is a diagram illustrating directions of a magnetic field according to a winding direction of a coil added to the embodiment of the present disclosure and current being applied; and

FIG. 4 is a diagram illustrating a state where heat is dissipated from the surface of the housing in the embodiment of the present disclosure.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, embodiments of the present disclosure will be described in detail with reference to the accompanying drawings so as to be easily embodied by those skilled in the art to which the present disclosure belongs.

The present disclosure relates to a structure for a housing of a power electronic part of a vehicle configured by filling a hollow portion with ellipsoidal magnetic particles coated with electrical insulation-type thermal conductive particles to form the surface layers, and a filling liquid.

The structure of the present disclosure is configured to change thermal conduction properties by changing the orientation of magnetic particles according to the direction of a magnetic field applied to the hollow portion, and heat dissipation performance and heat insulation performance can be selectively imparted to the structure itself in a case where the magnetic field applied to the hollow portion is controlled according to a heat generation state of the power electronic part accommodated in an internal space or a surrounding temperature.

The structure of the present disclosure can be used to configure a housing of the power electronic part such as the battery in an environment-friendly vehicle such as an electric vehicle or a hybrid vehicle, and particularly enables thermal conductivity control. Therefore, the structure is useful in configuring the housing for the power electronic part of a vehicle which selectively needs heat dissipation performance and heat insulation performance.

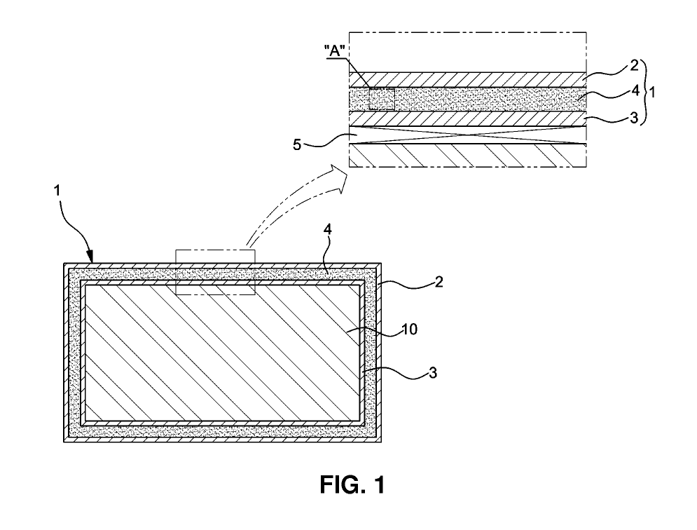

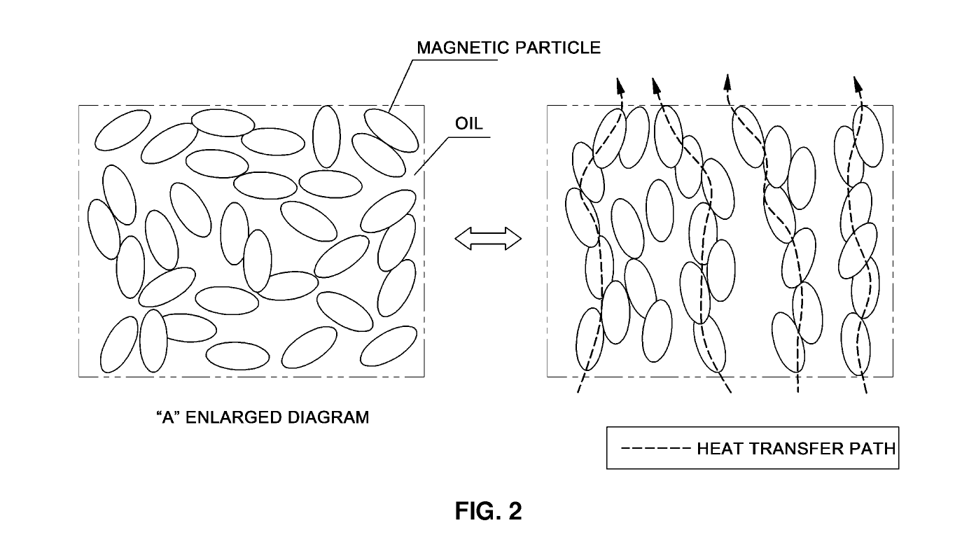

FIG. 1 is a cross-sectional view illustrating a structure of an embodiment, which is implemented as a housing of a power electronic part for a vehicle, and FIG. 2 is a schematic diagram illustrating an orientation state of magnetic particles filling a hollow portion of the structure.

First, the structure 1 of the embodiment may be implemented as the housing for the power electronic part manufactured to have a shape capable of protecting the power electronic part 10 mounted in the vehicle as illustrated in FIG. 1.

Here, the structure 1 of the present disclosure is manufactured to have a shape capable of enclosing the power electronic part 10 so as to be used as the housing, and the power electronic part 10 (for example, a battery) to be protected is accommodated in an internal space (a power electronic part accommodation space) formed by the structure 1 (hereinafter, referred to as “housing”).

In the embodiment, the housing 1 may be manufactured by being molded using a thermal conductive plastic material so as to enhance heat dissipation properties.

Here, the housing 1 (the structure filled with magnetic particles and a filling liquid) may be molded using an engineering plastic that contains a thermal conductive filler so as to transfer heat generated by the power electronic part 10 to the outside so as to be dissipated.

As an example, a plastic that contains the thermal conductive filler in a range of 30 to 60 weight % with respect to the plastic may be used. In this case, as a type of the thermal conductive filler, graphite or boron nitride formed as plate-like particles may be used. Otherwise, any type of thermal conductive filler may be employed as long as it can be dispersed in the plastic and molded while having thermal conduction properties.

In addition, the housing 1 is manufactured to have a structure with the hollow portion therein. The wall body of the housing 1 is formed to have a dual structure including an external wall body 2 and an internal wall body 3, and the hollow portion is provided between the external wall body 2 and the internal wall body 3.

Here, the hollow portion of the housing 1 has to be sealed after being filled with a filler 4 in which magnetic particles and a filling liquid are mixed. Therefore, the housing 4 may be manufactured to have a structure in which an open portion is provided on one side of the hollow portion and after filling the hollow portion with the filler, the hollow portion is sealed by assembling an additional wall body.

In addition, ribs (not illustrated) may be formed between the external wall body 2 and the internal wall body 3 at intervals. At this time, by the ribs, the rigidity of the structure of the housing can be reinforced, and the space of the hollow portion can be partitioned into a plurality of spaces.

For example, the hollow portion can be partitioned into several spaces using the ribs installed therein, and the rigidity of the housing can be controlled according to the structure, shape, position, and the like of the installed ribs. In addition, by a method of changing the amount of magnetic particles being filled or the like, heat transfer efficiencies of the spaces may be controlled to vary.

On the other hand, as the magnetic particles that fill the hollow portion in the present disclosure, magnetic particles coated with electrical insulation-type thermal conductive particles are used. In this case, as illustrated in FIG. 2, ellipsoidal magnetic particles may be used.

In a case where the ellipsoidal magnetic particles are used, as illustrated in the figure on the right of FIG. 2, compared to a case where circular magnetic particles are used, interparticle contact areas can be increased when a magnetic field is applied and the magnetic particles are oriented, which is advantageous to formation of three-dimensional heat transfer paths.

In a case where the magnetic field is applied to the filler 4 in the hollow portion, the magnetic particles are oriented in a magnetic flux direction. Since the ellipsoidal magnetic particles have magnetic anisotropy, the ellipsoidal magnetic particles can be oriented properly under the magnetic field, and thus thermal conductivity change responsiveness to the magnetic field can be increased.

In addition, the size of the magnetic particle may be of micron-scale particle size, and has to be a particle size that enables micro-Brownian motion while being able to settle in the filling liquid (silicone oil). For this, the magnetic particles may have a particle size in a range of 0.1 to 10 μm.

In addition, one selected from iron (Fe) particles, cobalt (Co) particles, and nickel (Ni) particles, and as amorphous alloy metal particles, iron-cobalt alloy metal particles and nickel-ion alloy metal particles may be used as the magnetic particles. In this case, magnetic particles coated with electrical insulation-type thermal conductive particles such as boron nitride particles, alumina particles, magnesium oxide particles, silicon nitride particles, silicon carbide particles, or diamond particles on the surfaces may be used.

The coated layers made by being coated with the electrical insulation-type thermal conductive particles as described above have electrical insulation and heat conduction properties. Therefore, the magnetic particles exhibit electrical insulation and heat conduction properties along with a property of being entirely oriented by the magnetic field.

Particularly, since the magnetic particles themselves have thermal conduction properties, as illustrated in the figure on the right of FIG. 2, in a state where the magnetic particles are oriented in the filling liquid in the hollow portion, heat transfer paths may be formed by interparticle contact (heat transfer paths are formed in a direction in which the particles are oriented).

As the filling liquid, a liquid having an appropriate viscosity, and desirably, a viscous liquid having electrical insulation properties may be used. A liquid having an appropriate viscosity and fluidity for the magnetic particles in the liquid to be oriented by the magnetic field in a state of being dispersed has to be used.

As an example of the filling liquid, a silicone oil may be used. After the hollow portion of the housing is filled with the silicone oil together with the above-mentioned magnetic particles, the hollow portion is sealed.

Finally, the structure 1 having a shape in which the power electronic part 10 is enclosed by the filler 4 made of the magnetic particles and the filling liquid in the hollow portion together with the hollow portion formed by the external wall body 2 and the internal wall body 3 may be configured, and the structure 1 may be used as a housing which provides a function of selecting heat dissipation and heat insulation depending on the operational condition of the power electronic part or surrounding environment conditions while protecting the power electronic part 10.

Particularly, the structure 1 may be used as a housing for a battery installed to enclose the battery, and as described later, in a case where the structure 1 is operated to provide the heat insulation function, degradation of the performance of the battery, which occurs in a low-temperature environment, can be prevented.

In addition, along with the filler 4 described above, a magnetic field generating member 5 which generates the magnetic field may be installed on the inside of the internal space (the power electronic part accommodation space) of the housing 1, and this may be a solenoid coil which generates a magnetic field when current is applied.

As an example of the installation of the solenoid coil, as illustrated in FIG. 1, the solenoid coil as the magnetic field generating member 5 is attached and installed on the inner surface of the internal space of the housing 1 to generate the magnetic field when current is applied.

In addition, the solenoid coil 5 has to be installed at a position at which the magnetic field generated when current is applied can be applied to the filler in the hollow portion, and has to be installed at an appropriate position with an appropriate size in consideration of the direction of the magnetic field which is to be applied to the hollow portion during heat dissipation and heat insulation.

In this case, as illustrated in the figure, the solenoid coil may be installed by being attached to the inner surface of the internal space (the power electronic part accommodation space) of the housing 1 in which the power electronic part 10 is embedded. However, the solenoid coil may be installed at any position at which the magnetic field generated when current is applied can be applied to the magnetic particles in the hollow portion, and if a structure that can insulate the coil itself is employed, the solenoid coil 5 may also be installed inside the hollow portion.

Accordingly, the structure of the embodiment can control thermal conductivity as the orientation of the magnetic particles is changed according to the direction of the magnetic field applied by the magnetic field generating member (coil) 5, and particularly, the structure can perform the function of selecting heat dissipation and heat insulation according to the orientation characteristics of the magnetic particles in the magnetic field.

More specifically, when current is applied to the solenoid coil 5 installed in the structure (housing) 1, the magnetic field is generated, and at the same time, the magnetic particles are oriented in the vertical direction and form heat transfer paths as illustrated in the figure on the right of FIG. 2.

Particularly, since the heat dissipation performance and the heat insulation performance can be selectively imparted on the housing depending on the direction of current that is applied to the solenoid coil, generation and interruption of the heat transfer paths can be selectively achieved as the magnetic field is generated depending on the direction of the current and the magnetic particles are moved along the direction of the magnetic field.

That is, in a case where the heat dissipation performance of the housing 1 is needed due to the heat generation state of the power electronic part 10 and a high surrounding temperature, the magnetic field is generated to be applied to the filler 4 in the hollow portion by applying current to the solenoid coil 5, and at the same time, the magnetic particles are oriented as illustrated in the figure on the right of FIG. 2. Therefore, heat transfer paths are formed by the oriented magnetic particles, thereby increasing thermal conductivity.

On the other hand, in a case where the heat insulation performance of the housing 1 is needed in a low-temperature environment, current having the same value is applied to the solenoid coil 5 in the reverse direction so as to apply a coercive electric field to the magnetic particles. Therefore, the magnetic particles are oriented at random (interruption of heat transfer paths) to implement the heat insulation performance of the housing, thereby preventing the degradation of the performance of the part 10.

In a case where current is applied while the magnetic particles are in their original state, that is, are in a state of not forming a network so as not to transfer phonons, the heat transfer paths are formed through the orientation by the magnetism. On the other hand, in a case of current reverse control, the network is not formed as original, and thus heat transfer is not made.

As described above, the direction of current that is applied to the solenoid coil is determined in consideration of the heat transfer paths due to the direction of the magnetic field and the orientation of the magnetic particles, and the heat dissipation or heat insulation performance demanded by the operational condition of the power electronic part or surrounding environment conditions.

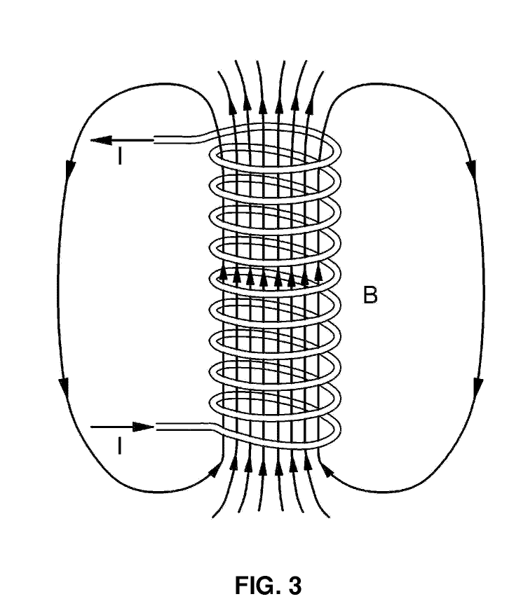

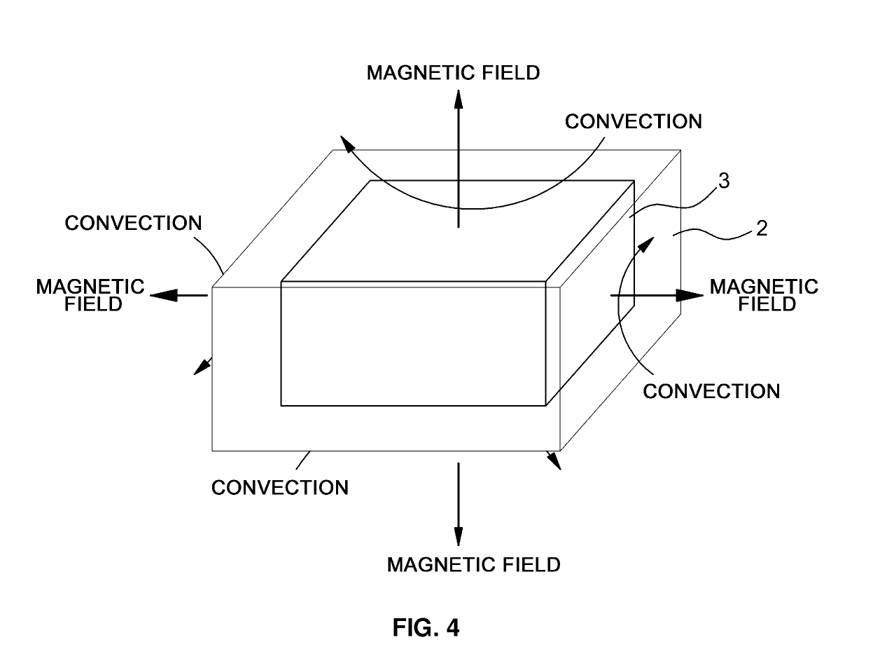

FIG. 3 is a diagram illustrating directions of a magnetic field according to a winding direction of a coil added to the embodiment and current being applied, and FIG. 4 is a diagram illustrating a state where heat is dissipated from the surface of the housing in the embodiment.

In FIG. 3, I represents the current direction, and B represents the magnetic field direction.

As illustrated, when the structure of the embodiment is configured as the housing of the power electronic part, the winding direction of the solenoid coil in consideration of the direction in which the magnetic field is formed is as illustrated in FIG. 2. In addition, when the magnetic field is generated by applying current to the coil due to the need for heat dissipation of the housing, thermal conductivity is increased by the orientation of the magnetic particles, and heat is dissipated from the surface of the housing through convection (air cooling).

While the embodiment of the present disclosure has been described in detail, the scope of the right of the present disclosure is not limited thereto, and various modifications and improved forms by those skilled in the art who use the basic concept of the present disclosure defined in the appended claims also belong to the scope of the right of the present disclosure.

What is claimed is:

1. A structure manufactured in a shape having a hollow portion, wherein
the hollow portion is configured to be filled with ellipsoidal magnetic particles coated with electrical insulation-type thermal conductive particles on their surfaces and a filling liquid fill in a state of being mixed with each other, wherein
thermal conductivity is able to be controlled by changing an orientation of magnetic particles according to a direction of a magnetic field applied by a magnetic field generating member.

2. The structure according to claim 1, wherein the magnetic particles are one selected from iron (Fe) particles, cobalt (Co) particles, and nickel (Ni) particles, and as amorphous alloy metal particles, iron-cobalt alloy metal particles and nickel-ion alloy metal particles.

3. The structure according to claim 1, wherein the thermal conductive particles are one selected from boron nitride particles, alumina particles, magnesium oxide particles, silicon nitride particles, silicon carbide particles, and diamond particles.

4. The structure according to claim 1, wherein the filling liquid is a silicone oil.

5. The structure according to claim 1, wherein the structure is molded to have the hollow portion using a thermal conductive engineering plastic that contains a thermal conductive filler, and is configured to fill the hollow portion with a filler made of the magnetic particles and the filling liquid.

6. The structure according to claim 5, wherein the thermal conductive filler is graphite or boron nitride formed as plate-like particles.

7. The structure according to any one of claims 1 to 5, wherein the structure is manufactured in a shape in which the hollow portion and the filler made of the magnetic particles and the filling liquid in the hollow portion are disposed to enclose a power electronic part and is provided as a housing for the power electronic part.

8. The structure according to claim 7, wherein the structure is provided as a battery housing, which is disposed to enclose a vehicle battery as the power electronic part.
